(19) United States
(12) Patent Application Publication
(10) Pub. No.: US 2024/0033604 A1
(43) Pub. Date: Feb. 1, 2024

(54) ELECTRONIC DEVICE, METHOD, AND COMPUTER-READABLE STORAGE MEDIUM FOR GUIDING MOVEMENT OF EXTERNAL OBJECT

(71) Applicant: THINKWARE CORPORATION, Seongnam-si (KR)

(72) Inventors: Sukpil KO, Seongnam-si (KR); Haejong CHOI, Seongnam-si (KR)

(73) Assignee: THINKWARE CORPORATION, Seongnam-si (KR)

(21) Appl. No.: 18/226,401

(22) Filed: Jul. 26, 2023

(30) Foreign Application Priority Data
Jul. 27, 2022 (KR) 10-2022-0093322
Jun. 29, 2023 (KR) 10-2023-0084533

(51) Int. Cl. A63B 71/06; G06T 7/50; G06T 7/70

(52) U.S. Cl. CPC A63B 71/0622; G06T 7/50; G06T 7/70; A63B 2102/32

(57) ABSTRACT

According to an embodiment, a processor of an electronic device may be configured to identify, based on data of a sensor, a first position of the electronic device. The processor may be configured to obtain, in response to an external object identified using the camera, information for moving the external object based on the first position. The processor may be configured to, while the external object is viewed through the display, display, based on the information, a visual object having a shape of a line extended from a second position in the display where the external object is viewed.

### CROSS-REFERENCE TO RELATED APPLICATION(S)

This application is based on and claims priority under 35 U.S.C. § 119 to Korean Patent Application No. 10-2022-0093322, filed on Jul. 27, 2022, in the Korean Intellectual Property Office, and Korean Patent Application No. 10-2023-0084533, filed on Jun. 29, 2023, in the Korean Intellectual Property Office, the disclosure of which is incorporated by reference herein in its entirety.

### BACKGROUND

### Technical Field

The present disclosure relate to an electronic device, a method, and a computer-readable storage medium for guiding movement of an external object.

### Description of Related Art

Electronic devices are being developed to support various services. In order to support services related to sports such as golf, an electronic device capable of processing a variety of information is recently under development.

### SUMMARY

A solution for guiding a user's action related to sporting activities based on augmented reality (AR) may be required.

According to an embodiment, an electronic device may include a display, a camera, a sensor, and a processor. The processor may be configured to the processor may be configured to identify, based on data of the sensor, a first position of the electronic device. The processor may be configured to obtain, in response to an external object identified using the camera, information for moving the external object based on the first position. The processor may be configured to, while the external object is viewed through the display, display, based on the information, a visual object having a shape of a line extending from a second position in the display where the external object is viewed.

According to an embodiment, a method of an electronic device may include identifying, based on data of a sensor of the electronic device, a first position of the electronic device. The method may include obtaining, in response to an external object identified using a camera of the electronic device, information for moving the external object based on the first position. The method may include, while the external object is viewed through a display of the electronic device, displaying, based on the information, a visual object having a shape of a line extending from a second position in the display where the external object is viewed.

According to an embodiment, a non-transitory computer-readable storage medium storing one or more programs is provided. The one or more programs may include instructions that, when executed by a processor of an electronic device, cause the electronic device to identify, based on data of a sensor of the electronic device, a first position of the electronic device. The one or more programs may include instructions that, when executed by the processor of the electronic device, cause the electronic device to obtain, in response to an external object identified using a camera of the electronic device, information for moving the external object based on the first position. The one or more programs may include instructions that, when executed by the processor of the electronic device, cause the electronic device to, while the external object is viewed through a display of the electronic device, display, based on the information, a visual object having a shape of a line extending from a second position in the display where the external object is viewed.

According to an embodiment, the electronic device can guide the user's action or actions related to sports based on augmented reality (AR).

According to an embodiment, the electronic device can visualize information for moving a golf ball, together with the golf ball visible to the user through a display.

### BRIEF DESCRIPTION OF THE DRAWINGS

The above and other aspects, features, and advantages of certain embodiments of the disclosure will be more apparent from the following description, taken in conjunction with the accompanying, in which:

FIG. 1 illustrates an example of a screen displayed by an electronic device, according to an embodiment;

FIG. 2 illustrates an example of a block diagram of an electronic device, according to an embodiment;

FIG. 3 illustrates an example of a flowchart of operation of an electronic device, according to an embodiment;

FIG. 4 illustrates an example of a screen displayed by an electronic device, according to an embodiment;

FIG. 5 illustrates an example of a screen displayed by an electronic device, according to an embodiment;

FIG. 6 illustrates an example of a screen displayed by an electronic device, according to an embodiment;

FIG. 7 illustrates an example of a screen displayed by an electronic device, according to an embodiment; and

FIG. 8 illustrates an example of a signal flow diagram of an electronic device and an external electronic device, according to an embodiment.

### DETAILED DESCRIPTION

Hereinafter, various embodiments of the present disclosure will be described in more detail with reference to the accompanying drawings.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar or like reference numerals may be used to refer to similar or like elements. It is to be understood that a singular form of a noun corresponding to an item may include one or more of the items, unless the relevant context clearly indicates otherwise. As used herein, each of such phrases as “A or B”, “at least one of A and/or B”, “at least one of A or B”, “A, B, or C”, “at least one of A, B, and/or C” may include any one of, or all possible combinations of the items enumerated together in a corresponding one of the phrases. As used herein, such terms as “ 1st”, “2nd”, “first”, or “second” may be used to simply distinguish a corresponding component from another, and does not limit the components in other aspect (such as e.g., importance or order). It is to be understood that if an element (e.g., a first element) is referred to, with or without the term “operatively” or “communicatively”, as “coupled with/to” or “connected with/to” another element (e.g., a second element), it means that the element may be coupled with the other element directly (e.g., wiredly), wirelessly, or via a third element.

As used in the present disclosure, the term “module” may include a unit implemented in hardware, software, or firmware, and may be interchangeably used with other terms, for example, “logic”, “logic block”, “part”, “circuit” or the like. A module may be a single integral component, or a minimum unit or a part thereof adapted to perform one or more functions. For example, a module may be implemented in a form of an application-specific integrated circuit (ASIC).

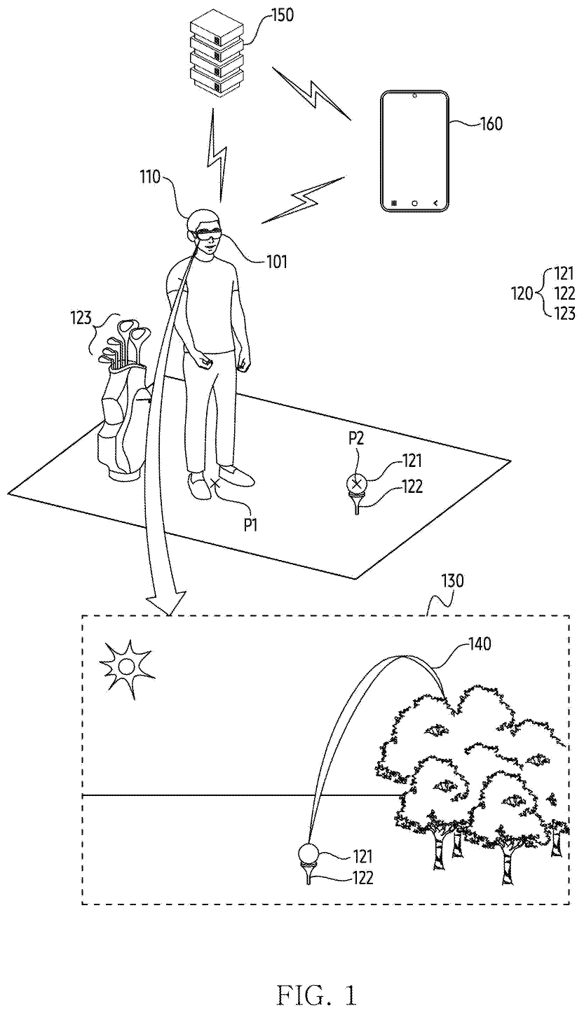

FIG. 1 illustrates an example of a screen 130 displayed by an electronic device 101, according to an embodiment. The electronic device 101 may take the form of a head-mounted device or head-mounted display (HMD) (or eyeglasses) that is wearable on a body part (e.g., head) of a user 110. While worn on the head of the user 110, the electronic device 101 may display a user interface (UI) based on augmented reality (AR), virtual reality (VR), mixed reality (MR), and/or extended reality (XR) to the eyes of the user 110. In terms of having the form of an HMD, the electronic device 101 may be referred to as a wearable device.

For example, the electronic device 101 may include a lens that, in a state of being worn on the head of the user 110, at least partially cover the eyes of the user 110. The electronic device 101 may project light representative of a UI provided by the electronic device 101 onto the lens. Based on the light projected onto the lens, the user 110 wearing the electronic device 101 may be able to view the UI (e.g., AR interface) provided by the electronic device 101, together with ambient light (or external light). Embodiments are not limited to thereto, and the electronic device 101 may utilize a camera to obtain images and/or video corresponding to the ambient light, and then synthesize the UI onto the images and/or video. The electronic device 101 may display the UI synthesized images and/or video on a display that is disposed in front of the eyes of the user 110 so as to obscure the ambient light, while worn on the head part of the user 110.

Referring now to FIG. 1, an example screen 130 displayed by the electronic device 101 worn by the user 110 is illustrated. The electronic device 101, including a lens configured to pass incident light from a first surface to a second surface opposite the first surface, may, in a state of being worn by the user 110, synthesize external light passing through the lens towards eyes of the user 110, with light for AR, to display the screen 130 to the user 110. The screen 130 may be formed on the lens by a combination of the external light and light projected onto the lens by the electronic device 101. Embodiments of the present disclosure are not limited thereto, and the screen 130 may be displayed within a display configured to cover the eyes of the user 110.

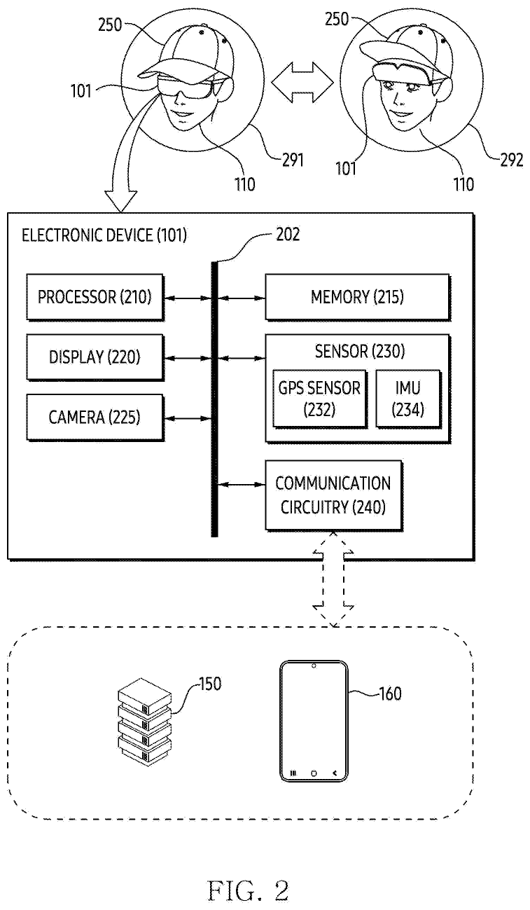

According to an embodiment, the electronic device 101 may perform functions related to an external environment (or external objects included in the external environment). The electronic device 101 may include one or more sensors and/or at least one camera for obtaining information about the external environment that includes the electronic device 101. Within an exemplary external environment as seen in FIG. 1, the electronic device 101 may identify external objects such as e.g., golf clubs 123, a golf ball 121, and/or a golf tee 122. The electronic device 101 may perform camera-based object recognition to identify the external objects. Such object recognition may include acquiring data indicative of a relative position of the external object with respect to the electronic device 101, a type (or class, category) of the external object, a shape and/or size of the external object. One or more hardware components included in the electronic device 101 to perform the functions related to the external environment based on object recognition will be exemplarily described with reference to FIG. 2. For implementing the object recognition, the electronic device 101 may include hardware (e.g., Neural Processing Unit (NPU)) and/or software for executing a neural network, such as e.g., Convolutional Neural Network (CNN).

Referring to FIG. 1, according to an embodiment, the electronic device 101 may execute information and/or functions related to a sporting event. Referring to FIG. 1, for example, while a user 110 wearing the electronic device 101 is playing golf, the electronic device 101 may perform operation and/or functions to guide actions of the user 110 related to playing golf. For example, the electronic device 101 may communicate with a user terminal 160 (e.g., smartphone) and/or a server 150 to identify a state of the user 110 related to playing golf. To identify the state of the user 110 related to playing golf, the electronic device 101 may recognize an external object, such as a golf ball 121, using at least one camera. To identify the state of the user 110 related to playing golf, the electronic device 101 may utilize one or more sensors to obtain information related to the user 110. For example, when the electronic device 101 is worn by the user 110, the electronic device 101 may determine a position P1 of the electronic device 101, identified based on data from the sensors, as the position of the user 110.

In an embodiment, after identifying a state of the user 110 related to playing golf, the electronic device 101 may display, within the screen 130, a visual object 140 for guiding an action of the user 110 related to playing golf based on the state. While the external object such as a golf ball 121 is viewed through the screen 130, the electronic device 101 may display, within the screen 130, the visual object 140 having a position, a shape, and/or a size associated with the golf ball 121. In the example state of FIG. 1, while the golf ball 121 positioned on a golf ball rest (or golf tee) 122 is viewable through the screen 130, the electronic device 101 may display, within the screen 130, the visual object 140 for guiding movement of the golf ball 121. The electronic device 101 may display the visual object 140 in the form of a line extending from a position of the golf ball 121 that is viewed through the screen 130.

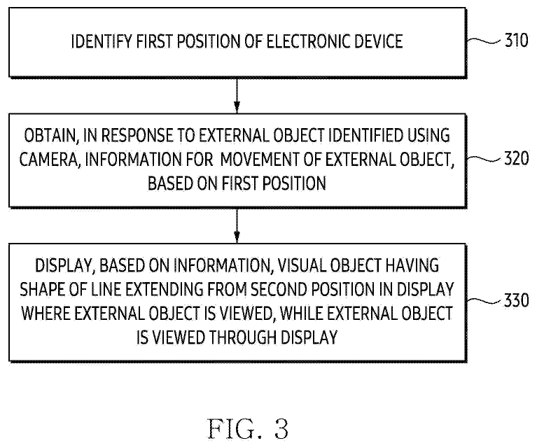

For example, the visual object 140 may represent a flying path or trajectory of the golf ball 121, as calculated by the electronic device 101. The electronic device 101 may calculate the flying path of the golf ball 121 represented by the visual object 140, based on information about the golf course identified via the server 150 (e.g., topography of the golf course) and the location of the golf ball 121 identified via the camera. An exemplary operation in which the electronic device 101 calculates the path of the golf ball 121 is described with reference to FIG. 3.

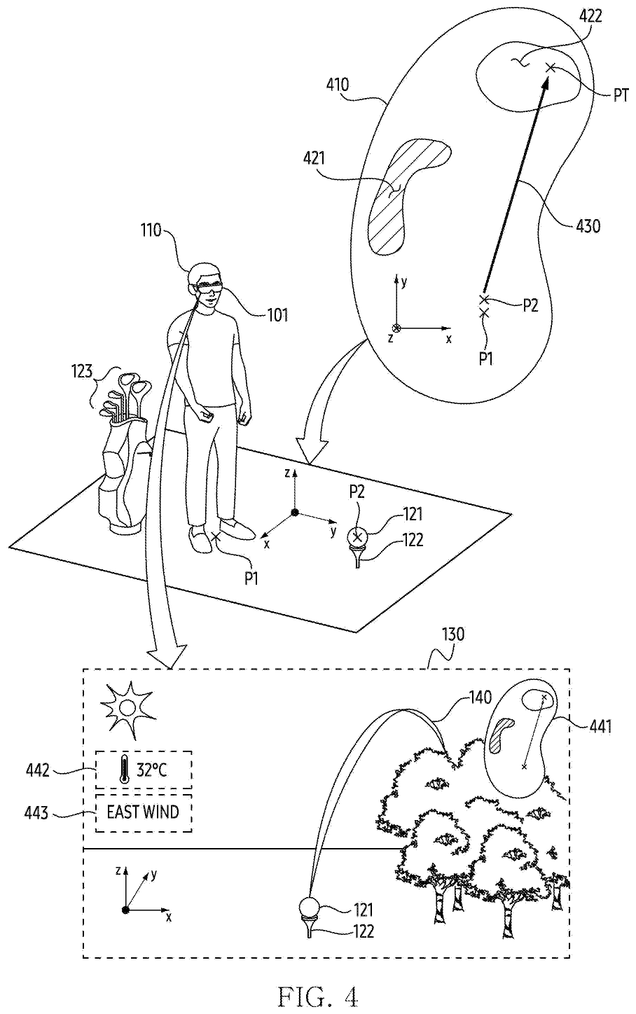

According to an embodiment, the information that the electronic device 101 displays via the screen 130 is not limited to the visual object 140. The electronic device 101 may visualize additional information, different from the visual object 140, to guide a flying path of the golf ball 121 in order to assist the user 110 in making his/her decision related to playing golf. An example of UI displayed by the electronic device 101 based on playing golf is illustrated with reference to FIGS. 4, 5, 6 and 7.

FIG. 2 illustrates an example of a block diagram of the electronic device 101, according to an embodiment. Referring to FIG. 2, the electronic device 101 may have an attachable structure that may be attached to a cap 250. For example, the electronic device 101 may include a clip and/or strap for fastening to a brim of the cap 250. The electronic device 101 may include a portion configured to cover or otherwise expose the eyes of the user 110 according to an action of the user 110. The portion may include a lens and/or a display 220.

For example, in a first state 291 being attached to the cap 250, the lens and/or the display 220 of the electronic device 101 may be positioned to cover both eyes of the user 110. In the first state 291, the user 110 may rotate the lens and/or the display 220 to switch to a second state 292. In the second state 292, the lens and/or the display 220 of the electronic device 101 may be rotated to take a shape and/or posture for exposing both eyes of the user 110 to the outside. Based on the first state 291, the user 110 may view information relating to a travelling path of the golf ball (e.g., the travelling path or trajectory of the golf ball 121 as represented by the visual object 140 of FIG. 1) from the electronic device 101. The first state 291 of providing the user 110 with the information related to the golf ball may be referred to as an address state. Having reviewed the information, the user 110 may enter the second state 292 to concentrate on the golf ball.

Referring to FIG. 2, the electronic device 101 according to an embodiment may include at least one of a processor 210, a memory 215, a display 220, a camera 225, a sensor 230, or communication circuitry 240. The processor 210, the memory 215, the display 220, the camera 225, the sensor 230, and the communication circuitry 240 may be electrically and/or operably coupled with each other by an electronic component, such as a communication bus 202. As used herein, when the hardware components are ‘operatively coupled’ with each other, it may mean that a direct or indirect connection between the hardware components may be established either by wire or wirelessly such that a second hardware component is controlled by a first hardware component, amongst the hardware components. Although the electronic device 101 is shown based on different blocks, the embodiments of the present disclosure are not limited thereto, and some of the hardware elements in FIG. 2 (e.g., at least part of the processor 210, the memory 215, and the communication circuitry 240) may be incorporated into a single integrated circuit, such as a system on a chip (SoC). The type and/or number of the hardware components included in the electronic device 101 are not limited to those illustrated in FIG. 2. For example, the electronic device 101 may include only some of the hardware components illustrated in FIG. 2.

According to an embodiment, the processor 210 of the electronic device 101 may include hardware components for processing data based on one or more instructions. The hardware components for processing the data may include, for example, an arithmetic and logic unit (ALU), a floating point unit (FPU), a field programmable gate array (FPGA), a central processing unit (CPU), and/or an application processor (AP). The number of processors 210 included in the electronic device 101 is not limited to that of the block diagram of FIG. 2. For example, the processors 210 may have the structure of a multi-core processor, such as a dual-core, a quad-core, or a hexa-core.

According to an embodiment, the memory 215 of the electronic device 101 may include hardware components for storing data and/or instructions that are input to and/or output from the processor 210. The memory 215 may include, for example, a volatile memory, such as random-access memory (RAM), and/or a non-volatile memory, such as read-only memory (ROM). The volatile memory may include, for example, at least one of dynamic RAM (DRAM), static RAM (SRAM), cache RAM, and pseudo SRAM (PSRAM). The non-volatile memory may include, for example, at least one of programmable ROM (PROM), erasable PROM (EPROM), electrically erasable PROM (EEPROM), flash memory, hard disk, compact disk (CD), solid state drive (SSD), embedded multi-media card (eMMC), or the like.

According to an embodiment, one or more instructions (or sets of instructions) for indicating operations and/or actions to be performed by processor 210 on data may be stored in the memory 215 of the electronic device 101. The set of one or more instructions may be referred to as a firmware, an operating system, a process, a routine, a subroutine, and/or a software application. For example, the electronic device 101 and/or the processor 210 may perform at least one of the operations illustrated in FIGS. 3 and/or 8, when the sets of a plurality of instructions distributed in the form of an operating system, firmware, a driver, and/or a software application are executed. As used herein, when an application is installed on the electronic device 101, it may mean that the one or more instructions, provided in the form of a software application, are stored within the memory 215 of the electronic device 101, wherein the one or more software applications are stored in a format that is executable by the processor 210 of the electronic device 101 (e.g., a file with an extension specified by the operating system of the electronic device 101). In an embodiment, a software application may be installed in the electronic device 101 for executing functions related to a sports activity of the user 110 inclusive of playing golf.

According to an embodiment, the display 220 of the electronic device 101 may output visualized information (e.g., the screen 130 of FIG. 1) to the user 110. For example, the display 220 may be controlled by a controller, such as e.g., a graphic processing unit (GPU), to output the visualized information to the user. The display 220 may include a liquid crystal display (LCD), a plasma display panel (PDP), and/or one or more light emitting diodes (LEDs). The LEDs may include organic LEDs (OLEDs). The display 220 may include a flat panel display (FPD) and/or electronic paper. Embodiments of the present disclosure are not limited thereto, and the display 220 may include a flexible display configured to have a shape that is at least partially curved, or deformable. The display 220 may be configured to project light toward a lens of the electronic device 101.

According to an embodiment, the sensor 230 of the electronic device 101 may generate electrical information that can be processed by the processor 210 and/or the memory 215, from non-electrical information related to the electronic device 101. For example, the sensors 230 may include a global positioning system (GPS) sensor 232 for detecting a geographic location of the electronic device 101. In addition to such a GPS method, the sensor 230 may generate information indicative of the geographic location of the electronic device 101, based on Global Navigation Satellite System (GNSS), such as, e.g., Galileo, Beidou, Compass or the like. The information may be stored in memory 215, processed by the processor 210, and/or transmitted via the communication circuitry 240 to another electronic device distinct from electronic device 101.

According to an embodiment, the sensor 230 of the electronic device 101 may include an inertial measurement unit (IMU) 234 for measuring motion (e.g., translational motion and/or rotational motion), position, orientation, and/or posture of the electronic device 101. The IMU 234 may include an acceleration sensor, a gyro sensor, a geomagnetic sensor, or a combination thereof. The acceleration sensor may output an electrical signal indicative of a gravitational acceleration and/or an acceleration in each of a plurality of axes (e.g., x-axis, y-axis, and z-axis) that are perpendicular to each other and based on a designated origin. The gyro sensor may output an electrical signal indicative of an angular velocity along each of the plurality of axes. The geomagnetic sensor may output an electrical signal indicative of a magnitude of a magnetic field formed in the electronic device 101 along each of the plurality of axes (e.g., x-axis, y-axis, and/or z-axis). The processor 210 may repeatedly receive, from the IMU 234, sensor data including the accelerations, the angular velocities, and/or the magnitudes of the magnetic fields along the plurality of axes, based on a designated periodicity (e.g., 1 millisecond). Using the sensor data from the IMU sensor 234, the processor 210 may measure the physical motion of the electronic device 101 based on six degrees of freedom (DoF) (e.g., x-axis, y-axis, z-axis, roll, pitch, yaw).

Referring to FIG. 1, the GPS sensor 232 and/or the IMU 234 are exemplarily shown as one example of the sensor 230 included in electronic device 101, but the embodiments of the present disclosure are not limited thereto. For example, the sensor 230 may include an image sensor, an illumination sensor, a depth sensor, a proximity sensor, a touch sensor, a grip sensor, and/or a time-of-flight (ToF) sensor, for detecting electromagnetic waves inclusive of light.

According to an embodiment, the camera 225 of the electronic device 101 may include one or more light sensors (e.g., charged coupled device (CCD) sensor, complementary metal oxide semiconductor (CMOS) sensor) that generate an electrical signal indicative of color and/or brightness of light. The plurality of light sensors included in the camera 225 may be arranged in the form of a two-dimensional array. The camera 225 may acquire electrical signals from each of the plurality of light sensors substantially simultaneously to obtain a two-dimensional frame image corresponding to light reaching the light sensors in a two-dimensional grid. For example, photographic data captured using the camera 225 may refer to a two-dimensional frame image obtained from the camera 225.

For example, video data captured using the camera 225 may refer to a sequence of a plurality of two-dimensional frame images obtained from camera 225.

In an embodiment, the camera 225 may include a flash light and/or an infrared diode that emits light to an exterior of the camera 225. The camera 225 may include one or more infrared light sensors to detect intensity of infrared light. The camera 225 may utilize the one or more infrared light sensors to measure the degree to which infrared light emitted from the infrared diode is reflected. In an embodiment, the degree of reflection of the infrared light may be measured substantially simultaneously with a plurality of infrared light sensors included in the camera 225. The camera 225 may generate a frame image including a depth value, based on the degree to which the infrared light measured by the plurality of infrared light sensors is reflected. The depth value may be related to a distance between the camera 225 and a subject captured by the camera 225 and/or included in the frame image.

According to an embodiment, the number of cameras 225 included in the electronic device 101 may be one or more. When the electronic device 101 includes a plurality of cameras, the plurality of cameras may have their own independent orientations and/or field-of-views (FoV). The FoV is a region formed based on a view angle from which the lens of the camera 225 can receive light, and may be related to a size of an external space corresponding to the image and/or the video generated by the camera 225.

According to an embodiment, the communication circuitry 240 of electronic device 101 may include hardware components to support transmission and/or reception of electrical signals between the electronic device 101 and an external electronic device (e.g., a server 150 and/or a user terminal 160). The communication circuitry 240 may include, for example, at least one of a modem, an antenna, and an optic/electronic (O/E) converter. The communication circuitry 240 may support the transmission and/or the reception of electrical signals, based on various types of protocols, such as Ethernet, local area network (LAN), wide area network (WAN), wireless fidelity (WiFi), near field communication (NFC), Bluetooth, Bluetooth low energy (BLE), ZigBee, Long Term Evolution (LTE), 5G new radio (NR), and/or 6G. Although the electronic device 101 is illustrated as being directly connected via the communication circuitry 240 to an external electronic device, such as the server 150 and/or the user terminal 160, the electronic device 101 may be indirectly connected to the external electronic device via one or more routers and/or access points (APs).

Referring to FIG. 2, the server 150 with which the electronic device 101 communicates via the communication circuitry 240 may be configured to provide information related to the sports activity of the user 110. For example, when the user 110 is located at a golf course, the electronic device 101 may communicate with the server 150 based on the location of the golf course identified via the GPS sensor 232. While in communication with the server 150 based on the location of the golf course, the electronic device 101 may receive information (e.g., topography and/or weather) related to the golf course from the server 150 via the communication circuitry 240.

Referring to FIG. 2, the user terminal 160 with which the electronic device 101 communicates via the communication circuitry 240 may include a smartphone carried by the user 110 of the electronic device 101. The electronic device 101 may utilize resources of the user terminal 160 to reduce the amount of computation. For example, the electronic device 101 may obtain information for displaying the visual object 140 of FIG. 1, based on computations performed in the user terminal 160. In this example, the electronic device 101 may use the user terminal 160 to reduce power consumption and/or heat generation of the electronic device 101.

FIG. 3 illustrates an example of a flowchart of operation of an electronic device, according to an embodiment. The electronic device 101 of FIGS. 1 and 2 and/or the processor 210 of FIG. 2 may perform the operations described with reference to FIG. 3. Referring to FIG. 3, in operation 310, the processor of the electronic device may

identify a first position of the electronic device, according to an embodiment. The processor may identify the first position of the electronic device, based on data from a sensor (e.g., the GPS sensor 232 of FIG. 2). Based on the first position in the operation 310, the processor may obtain information about an area (e.g., a golf course) where the electronic device is located. For example, the processor may communicate with a server (e.g., the server 150 of FIGS. 1 and 2) using communication circuitry (e.g., the communication circuitry 240 of FIG. 2) to obtain the information about the area.

Referring to FIG. 3, in operation 320, the processor of the electronic device according to an embodiment, may obtain, in response to an external object identified using a camera (e.g., the camera 225 of FIG. 2), information for movement of the external object, based on the first position. The information of the operation 320 may be obtained based on identifying a specified type of external object for a sport, such as a golf ball 121 of FIG. 1. Hereinafter, among the external objects identified by the electronic device, the external object (e.g., the golf ball 121 of FIG. 1) for which a travelling path (or trajectory) is to be calculated may be referred to as a target external object. The processor may utilize information in the electronic device about the area (e.g., topography of the golf course), which was obtained based on the first position in the operation 310, to obtain information for the movement of the external object (e.g., the target external object) in the operation 320. The processor may obtain information in the operation 320 to guide the user's actions required to move the external object, based on a relative position of the external object with respect to the first position of the electronic device. The processor may obtain information of the operation 320, based on another external object and/or topography distinct from the golf ball, identified via the camera. Identifying the topography through the camera may include identifying, by the processor, a three-dimensional model of the topography. For example, the processor that identified the golf ball may obtain, based on the operation 320, information related to the user's posture, position, orientation, and/or golf club for striking the golf ball. For example, the processor that identified the golf ball may use information about the electronic device and/or the golf course in which the user wearing the electronic device is located to identify a target position of the golf ball.

Referring to FIG. 3, in operation 330, according to an embodiment, the processor of the electronic device may display, based on the information in operation 320, a visual object (e.g., the visual object 140 of FIG. 1) having the form of a line extending from a second position in the display where the external object (e.g., the target external object) is viewed, while the external object is viewed through the display (e.g., the display 220 of FIG. 2). The processor may display the visual object, based on a third position in an external space of an external object identified using the camera and a target position in the external space with respect to the external object. The target position may be indicated by information from the operation 320.

Although an embodiment in which the processor of the electronic device uses a display to visualize information for movement of the external object has been described, the embodiments of the present disclosure are not limited thereto. For example, the processor may output a sound signal including information of the operation 320 through a speaker. The sound signal may include at least one natural language sentence representing the information.

FIG. 4 illustrates an example of a screen 130 displayed by the electronic device 101, according to an embodiment. The electronic device 101 of FIGS. 1 and 2 may perform the operation of the electronic device 101 described with reference to FIG. 4. The operations of the electronic device 101 described with reference to FIG. 4 may be related to at least one of the operations of FIG. 3.

Referring to FIG. 4, an example state of the electronic device 101 included in an external space corresponding to a golf course 410 is illustrated. The electronic device 101 may identify the external space, based on an external electronic device (e.g., the server 150 of FIGS. 1 and 2) connected via communication circuity (e.g., the communication circuitry 240 of FIG. 2). In an example state of the electronic device 101 positioned in the golf course 410, the electronic device 101 may identify the external space including a target position PT of a golf ball 121, based on the external electronic device. The target position PT may be a location of the hole cup in the golf course 410. When the electronic device 101 identifies the external space corresponding to the golf course 410, the electronic device 101 may identify a bunker 421, a green zone 422, road, hazard, and/or fairway that are included in the golf course 410. The electronic device 101 may identify the topography, a shape, and/or a size of the golf course 410.

According to an embodiment, the electronic device 101 may identify a first position P1 (e.g., the first position in operation 310 of FIG. 3) of the electronic device 101 in the external space, based on information obtained via an external electronic device and/or a camera (e.g., the camera 225 of FIG. 2). The electronic device 101 may identify a position P2 of the golf ball 121, based on the information obtained via the camera. The electronic device 101 may identify the first position P1 of the electronic device 101 within the external space, using data from the GPS sensor 232, the camera 225, and/or the IMU 234 of FIG. 2. Based on the weather information obtained from the external electronic device and/or the motion of an external object identified via the camera (e.g., another external object different from the target external object, such as e.g., leaves and/or grass), the electronic device 101 may obtain weather information of the external space adjacent to the electronic device 101. The weather information may include wind direction and/or wind speed. For example, the processor may identify a wind direction and/or speed to be applied to the golf ball 121, based on the weather in the external space as indicated by the weather information. Based on the direction and/or speed of the wind to be applied to the golf ball 121 and the target position PT in the golf course 410, the electronic device 101 may obtain information for movement of the golf ball 121. The information may indicate a travelling path 430 for moving the golf ball 121 from the current location P2 of the golf ball 121 to the target position PT in the golf course 410, which is an external space identified by the electronic device 101. In an embodiment, the electronic device 101 may utilize the resources of the user terminal 160 of FIGS. 1 and 2 to obtain information for movement of the golf ball 121. Referring to FIG. 4, the electronic device 101 that has obtained information for

the movement of the golf ball 121 may display the visual object 140 based on the information within the screen 130. The visual object 140 may have the form of a line extending in three dimensions from a position in the screen 130 of the golf ball 121, while the golf ball 121 is visible on the screen 130. The electronic device 101 may transmit light with a binocular disparity to the user's two eyes to display the visual object 140 in three dimensions. For example, the binocular disparity of a portion of the visual object 140 adjacent to the golf ball 121 may be greater than the binocular disparity of another portion of the visual object 140 toward the target position PT, because the golf ball 121 is positioned closer to the target position PT relative to the electronic device 101.

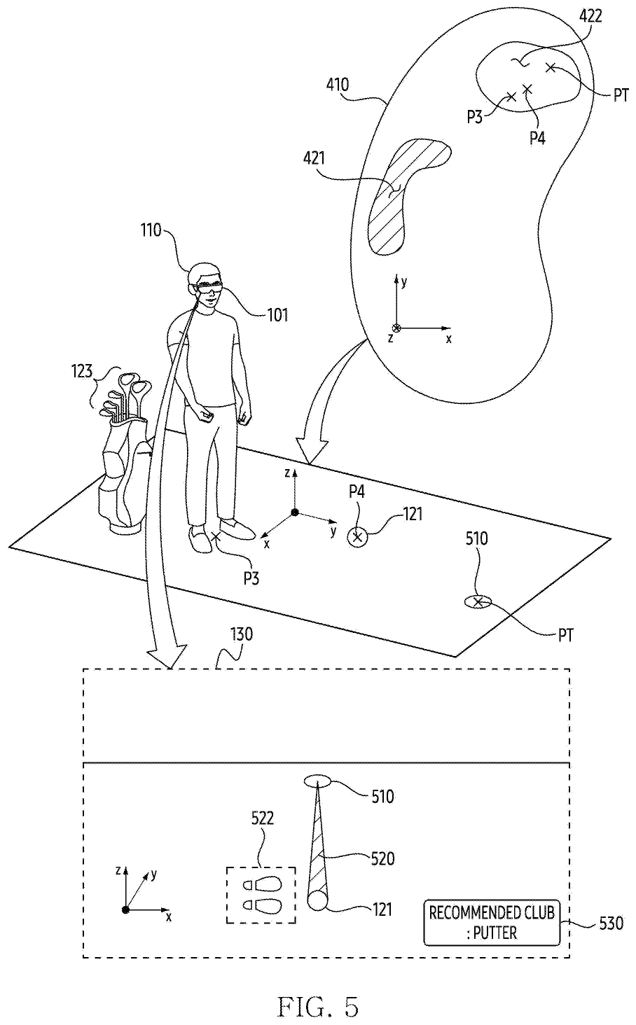

Referring to FIG. 4, the electronic device 101 may display visual objects 441, 442 and/or 443 that include information about the external space inclusive of the golf course 410, along with the visual object 140 for guiding the travelling path 430 of the golf ball 121. For example, the electronic device 101 may display, within the screen 130, a visual object 441 that has the form of a mini-map of the golf course 410. Using the visual object 441, the electronic device 101 may display the position of the electronic device 101 within the golf course 410 and/or the target position (PT). The electronic device 101 may display, within the screen 130, visual objects 442 and/or 443 that include weather information for the external space inclusive of the golf course 410. The electronic device 101 may display the temperature of the external space using the visual object 442, which may have the form of a thermometer. The electronic device 101 may display a wind direction, utilizing the visual object 443 including text indicating the wind direction (e.g., “east wind”). FIG. 5 illustrates an example of the screen 130 displayed by the electronic device

101, according to an embodiment. The electronic device 101 of FIGS. 1 and 2 may perform the operations of the electronic device 101 described with reference to FIG. 5. The operations of the electronic device 101 described with reference to FIG. 5 may be related to at least one of the operations of FIG. 3.

Referring to FIG. 5, it is illustrated an example state of the electronic device 101 located at a position P3 within a green zone 422 of a golf course 410. The electronic device 101 may utilize the GPS sensor 232 of FIG. 2 to identify the position P3 within the golf course 410 of the electronic device 101. The electronic device 101 may identify a position P4 of the golf ball 121 using the camera 225 of FIG. 2. While it is positioned on the golf course 410, the electronic device 101 may obtain information to guide the actions of the user 110 related to playing golf. The information may include information for moving the golf ball 121, as described above with reference to FIG. 4.

According to an embodiment, the electronic device 101 may execute a function for recommending one golf club to be selected for moving the golf ball 121 from a set of golf clubs 123 that may be used for moving the golf ball 121. The electronic device 101 may obtain information about the golf clubs 123 from the user 110. The information about the golf clubs 123 may be obtained by a UI provided via the electronic device 101 and/or a user terminal (e.g., the user terminal 160 of FIGS. 1 and 2). Based on executing the function, the electronic device 101 may obtain information for recommending a certain golf club. Within the example state of FIG. 5, the electronic device 101 may identify one of the golf clubs 123, based on at least one of the position P3 of the electronic device 101 in the golf course 410, the position P4 of the golf ball 121, or the target position PT of the hole cup 510. For example, the electronic device 101 may identify one golf club suitable for moving the golf ball 121 and/or a travelling path of the golf ball 121 associated with the golf club, based on at least one of a distance between the golf ball 121 and a hole cup 510, topography of the golf course 410 between the golf ball 121 and the hole cup 510, or weather information identified via the electronic device 101 and/or an external electronic device (e.g., the server 150 of FIGS. 1 and 2).

Referring to FIG. 5, having identified the golf ball 121 located within the green zone 422, the electronic device 101 may identify a golf club (e.g., a putter) suitable for use in the green zone 422 among the golf clubs 123 in order to move the golf ball 121 to the hole cup 510 within the green zone 422. The electronic device 101 may display, within the screen 130, a visual object 530 related to the identified golf club. The visual object 530 may include a name of the golf club identified by the electronic device 101. In an example state of recommending a putter, the electronic device 101 may display, within the screen 130, a visual object 520 representing a travelling path of the golf ball 121 based on the putter. Together with the visual object 520 representing the travelling path of the golf ball 121, the electronic device 101 may display, within the screen 130, a visual object 522 for guiding the position of the user 110. The visual object 520 may correspond to a putting line. Based on the topography of the golf course 410 identified by the camera, the electronic device 101 may make an adjustment of the putting line. Referring to FIG. 5, it is illustrated an example state of the electronic device 101 displaying the visual object 522 having the form of the user's footprint to guide the position of the user 110, but the embodiments of the present disclosure are not limited thereto.

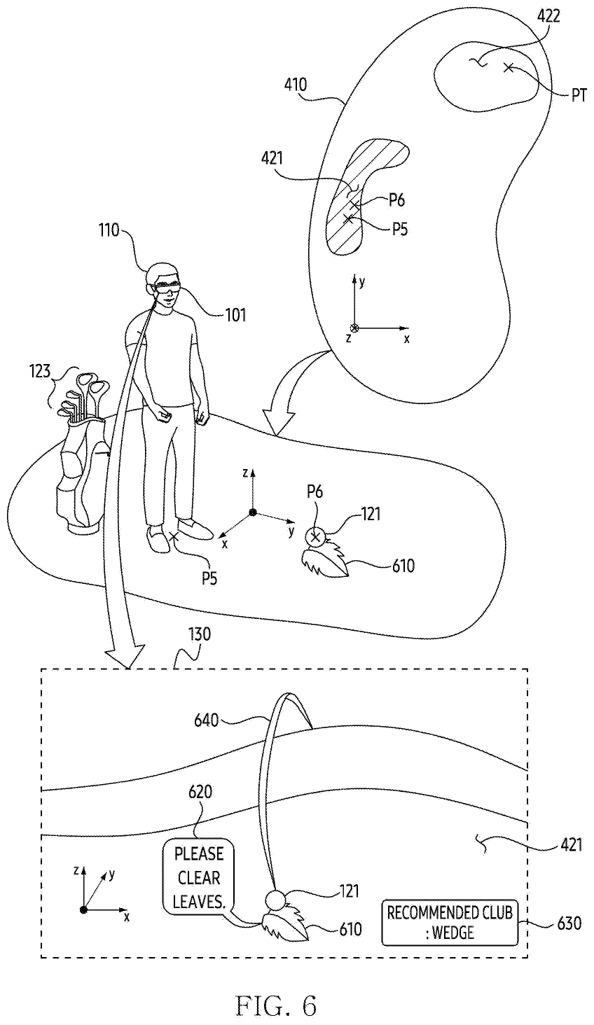

FIG. 6 illustrates an example of a screen 130 displayed by the electronic device 101, according to an embodiment. The electronic device 101 of FIGS. 1 and 2 may perform the operations of the electronic device 101 described with reference to FIG. 6. The operations of the electronic device 101 described with reference to FIG. 6 may be related to at least one of the operations of FIG. 3.

Referring to FIG. 6, an example state of the electronic device 101 located at a position P5 in a bunker 421 of a golf course 410 is illustrated. The electronic device 101 may utilize an external electronic device (e.g., the server 150 of FIGS. 1 and 2) having information (or a database) related to the golf course 410 to identify that the position P5 of the electronic device 101 is located within the bunker 421. The electronic device 101 may identify the topography of the bunker 421 via the external electronic device. The electronic device 101 may utilize the camera 225 of FIG. 2 to identify the topography of the bunker 421 in which the electronic device 101 is located.

Referring to FIG. 6, having identified the golf ball 121 at a position P6 within the bunker 421, the electronic device 101 may guide movement of the golf ball 121 based on the topography of the external space (e.g., the bunker 421) adjacent to the golf ball 121. Based on the bunker 421 where the golf ball 121 is located, the electronic device 101 may identify one golf club (e.g., a wedge), amongst a set of golf clubs 123, for use in moving the golf ball 121. The electronic device 101 may display a visual object 630 associated with the identified golf club within the screen 130. The electronic device 101 may display, within the screen 130, a visual object 640 for guiding the travelling path of the golf ball 121 to be moved based on the identified golf club.

According to an embodiment, the electronic device 101 may identify, based on object recognition, another external object and/or topography related to the movement of the golf ball 121, which is a target. For example, the electronic device 101 may identify other external objects that may interfere with movement of the golf ball 121, such as e.g., a leaf/leaves 610 located in the vicinity of the position P6 of the golf ball 121. In the state of FIG. 6 with the leaf 610 being identified, the electronic device 101 may display a visual object 620 within the screen 130 to inform the user of existence of the leaf 610. For example, the electronic device 101 may display the visual object 620 in the form of a bubble that includes text (e.g., “Please clear leaves.”) to guide to move the leaf 610. The embodiments of the present disclosure are not limited to thereto.

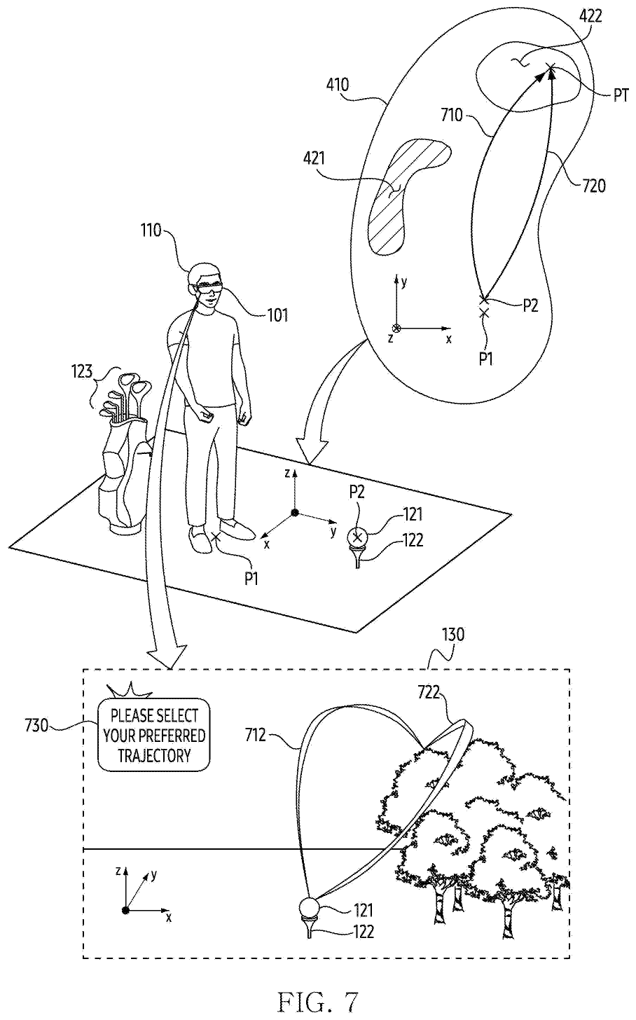

FIG. 7 illustrates an example of a screen 130 displayed by the electronic device 101, according to an embodiment. The electronic device 101 of FIGS. 1 and 2 may perform the operations of the electronic device 101 described with reference to FIG. 7. The operations of the electronic device 101 described with reference to FIG. 7 may be related to at least one of the operations of FIG. 3.

Referring to FIG. 7, it is illustrated an example state of the electronic device 101 located at a position P1 within a golf course 410. The electronic device 101 may identify one or more candidate paths associated with the golf ball 121, based on a target position PT within the golf course 410 and/or a position P2 of the golf ball 121 identified via a camera (e.g., the camera 225 of FIG. 2). Referring to FIG. 7, it is illustrated the example state of the electronic device 101 that have identified a plurality of candidate paths 710 and 720. The plurality of candidate paths 710 and 720 may correspond to each of the golf clubs 123 of the user 110. For example, the electronic device 101 may obtain the candidate paths 710, 720 corresponding to each of the different golf clubs 123, based on weights and/or driving distances of the golf clubs 123. The electronic device 101 may obtain the candidate paths 710 and 720, based on the weather information, the topography of the golf course 410, the position P2 of the golf ball 121, and/or the target position PT.

Referring to FIG. 7, in the example state of having identified a plurality of candidate paths 710 and 720, the electronic device 101 may display visual objects 712 and 722 corresponding to each of the candidate paths 710, 720 within the screen 130. With the golf ball 121 being viewable on the screen 130, the electronic device 101 may display the visual objects 712 and 722 in the form of lines extending from the position of the golf ball 121 in the screen 130. While in the state of displaying the candidate paths 710 and 720, the electronic device 101 may receive an input indicating a selection of any one of the candidate paths 710 and 720, within the screen 130. The electronic device 101 may display a visual object 730 to guide the input, within the screen 130. Although the visual object 730 is, by way of an example, shown in the form of a pop-up-window including a specified text (such as, e.g., “Please select your preferred trajectory.”) to guide the input, the embodiments of the present disclosure are not limited thereto. For example, the electronic device 101 may output, to the user 110, a sound signal corresponding to the text included in the visual object 730.

In an embodiment, while displaying the visual objects 712 and 722 corresponding to the plurality of candidate paths 710 and 720, the electronic device 101 may receive an input indicating a selection of any one of the plurality of candidate paths 710 and 720. The input may be received based on a hand gesture, gaze or utterance of the user 110, or one or more buttons configured on the electronic device 101. For example, the electronic device 101 may identify the input, based on a touch gesture performed on the housing and/or a hand gesture performed in an external space spaced apart from the electronic device 101. For example, the electronic device 101 may identify the input, based on a user's gaze facing either one of the visual objects 712 and 722. For example, the electronic device 101 may identify the input, based on utterance of the user 110 that is provided based on a natural language sentence. For example, the electronic device 101 may identify the input, based on the pressing of a designated button.

In an embodiment, based on the input indicating a selection of any one of a plurality of candidate paths 710 and 720, the electronic device 101 may display, on the screen 130, one visual object corresponding to the candidate path matching the input, amongst the visual objects 712 and 722, and may at least temporarily cease displaying the other visual object on the screen 130. The electronic device 101 having identified the input may further display, within the screen 130, a visual object including text, icons, and/or images indicating one golf club, amongst the golf clubs 123, that is matched to the candidate path corresponding to the input. The electronic device 101 having identified the input may at least temporarily cease displaying the visual object within the screen 130.

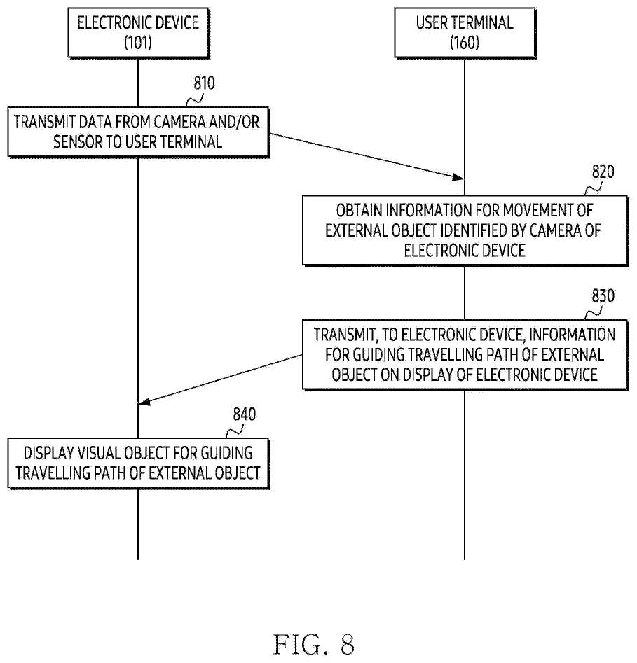

FIG. 8 illustrates an example of a signal flow diagram of the electronic device 101 and an external electronic device (e.g., the user terminal 160), according to an embodiment. The electronic device 101 of FIGS. 1 and 2 and/or the processor 210 of FIG. 2 may perform the operations of the electronic device 101 described with reference to FIG. 8. The operations of the electronic device 101 described with reference to FIG. 8 may be related to at least one of the operations of FIG. 3.

Referring to FIG. 8, in operation 810, according to an embodiment, the processor of the electronic device 101 may transmit data from a camera (e.g., the camera 225 of FIG. 2) and/or a sensor (e.g., the sensor 230 of FIG. 2) to the user terminal 160. The processor may perform operation 810 to obtain information for movement of an external object (e.g., a target external object such as e.g., the golf ball 121 of FIGS. 1, 2, 3, 4, 5, 6 and 7), based on a calculation of the user terminal 160. The processor may perform the operation 810, based on a state of the electronic device 101 inclusive of a state of charge (SOC) and/or temperature of a battery of the electronic device 101. For example, when the SOC of the battery is less than a specified threshold of SOC, or the temperature of the electronic device 101 exceeds a specified threshold temperature, the processor may request the user terminal 160 to perform the operation 810 to obtain information for the movement of the external object.

Referring to FIG. 8, in operation 820, according to an embodiment, the processor of the user terminal 160 may obtain information for the movement of the external object identified by the camera of the electronic device. The processor of the user terminal 160 may identify the data of the operation 810, based on a signal transmitted from communication circuitry of the electronic device 101 (e.g., the communication circuitry 240 of FIG. 2). Based on the data of the operation 810, the processor of the user terminal 160 may obtain information for the movement of the external object. The processor of the user terminal 160 may obtain the information of the operation 820, by performing the operations of the electronic device 101 described with reference to FIGS. 1, 2, 3, 4, 5, 6, and 7. For example, the processor of the user terminal 160 may obtain information for the movement of the external object, based on the execution of a neural network.

Referring to FIG. 8, in operation 830, according to an embodiment, the processor of the user terminal 160 may transmit, to the electronic device, information for guiding the travelling path of the external object on a display of the electronic device (e.g., the display 220 of FIG. 2). The processor of the user terminal 160 may perform the operation 830 to transmit the information obtained based on the operation 820 to the electronic device 101.

Referring to FIG. 8, in operation 840, according to an embodiment, the processor of the electronic device 101 may display the visual object for guiding the travelling path of an external object. Based on receiving information of the operation 840 from the user terminal 160, the processor of the electronic device 101 may display the visual objects indicated by the received information, within the display. The processor of the electronic device 101 may display the visual object of the operation 840, while the external object is visible through the display to a user wearing the electronic device 101 (e.g., the user 110 of FIG. 1).

As described above with reference to FIG. 8, according to an embodiment, the electronic device 101 may obtain information for the movement of the external object, using the processor of the user terminal 160 as well as the processor of the electronic device 101. While the electronic device 101 is worn on the user's head, the calculations performed by the processor of the electronic device 101 may cause an increase in heat transferred from the electronic device 101 to the user's head. To prevent such an increase in heat, the electronic device 101 may request the processor of the user terminal 160, which is located away from the head, to perform calculations to obtain information for the movement of the external object.

As described above, according to an embodiment, the electronic device 101 can display a visual object for guiding a user in a sporting activity, including playing golf. The electronic device 101 can obtain information for displaying the visual object, based on information obtained from the electronic device 101 and/or an external electronic device. The electronic device 101 can display to the user an image and/or video obtained by synthesizing the visual object with the external object including the golf ball, thereby guiding the user for movement of the external object.

As described above, according to an embodiment, the electronic device may comprise a display, a camera, a sensor, and a processor. The processor may be configured to identify, based on data of the sensor, a first position of the electronic device. The processor may be configured to obtain, in response to an external object identified using the camera, information for moving the external object based on the first position. The processor may be configured to, while the external object is viewed through the display, display, based on the information, a visual object having a shape of a line extending from a second position in the display where the external object is viewed.

For example, the processor may be configured to display the visual object, based on a third position in an external space of the external object identified using the camera and a target position in the external space for the external object.

For example, the processor may be configured to display, on the display, the visual object having the shape of the line extending from the second position toward the target position.

For example, the electronic device of may further comprise communication circuitry. The processor may be configured to identify, based on an external electronic device connected via the communication circuitry, the external space including the target position.

For example, the processor may be configured to obtain the information, based on topography of the external space identified based on the external electronic device.

For example, the processor may be configured to obtain the information for moving the external object, based on weather condition of the external space identified using the external electronic device.

For example, the processor may be configured to identify, based on the weather, at least one of a direction or a velocity of wind to be applied to the external object, the external object including a golf ball. For example, the processor may be configured to obtain the information, based on at least one of the direction or the speed.

For example, the visual object may be a first visual object. The processor may be configured to obtain the information for recommending, from a plurality of golf clubs, one golf club to be utilized for moving the external object, the external object including a golf ball. The processor may be configured to display a second visual object related to the golf club to be recommended based on the information.

As described above, according to an embodiment, the method of an electronic device may comprise identifying, based on data of a sensor of the electronic device, a first position of the electronic device. The method may comprise obtaining, in response to an external object identified using a camera of the electronic device, information for moving the external object based on the first position. The method may comprise, while the external object is viewed through a display of the electronic device, displaying, based on the information, a visual object having a shape of a line extended from a second position in the display where the external object is viewed.

For example, the displaying may comprise displaying the visual object based on a third position in an external space of the external object identified using the camera and a target position in the external space for the external object.

For example, the displaying may comprise displaying, on the display, the visual object having the shape of the line extended from the second position toward the target position.

For example, the obtaining may comprise identifying, based on an external electronic device connected via communication circuitry of the electronic device, the external space including the target position.

For example, the obtaining may comprise obtaining the information, based on topography of the external space identified based on the external electronic device.

For example, the obtaining may comprise obtaining the information for moving the external object, based on weather of the external space identified using the external electronic device.

For example, the obtaining may comprise identifying, based on the weather, at least one of a direction or a speed of wind to be applied to the external object, the external object including a golf ball. The method may further comprise obtaining the information based on at least one of the direction or the speed.

For example, the visual object may be a first visual object. The obtaining may comprise obtaining the information for recommending, from a plurality of golf clubs, one golf club to be utilized for moving the external object, the external object including a golf ball. The method may further comprise displaying a second visual object related to the golf club to be recommended based on the information.

As described above, according to an embodiment, a non-transitory computer-readable storage medium storing one or more programs is provided. The one or more programs may comprise instructions that cause, when executed by a processor of an electronic device, to identify, based on data of a sensor of the electronic device, a first position of the electronic device. The one or more programs may comprise instructions that cause, when executed by a processor of an electronic device, to obtain, in response to an external object identified using a camera of the electronic device, information for moving the external object based on the first position. The one or more programs may comprise instructions that cause, when executed by a processor of an electronic device, to display, based on the information, a visual object having a shape of a line extended from a second position in the display where the external object is viewed, while the external object is viewed through a display of the electronic device.

For example, the one or more programs may comprise instructions that cause, when executed by the processor of the electronic device, to display the visual object, based on a third position in an external space of the external object identified using the camera and a target position in the external space for the external object.

For example, the one or more programs may comprise instructions that cause, when executed by the processor of the electronic device, to display, on the display, the visual object having the shape of the line extended from the second position toward the target position.

For example, the one or more programs may comprise instructions that cause, when executed by the processor of the electronic device, to identify, based on an external electronic device connected via communication circuitry of the electronic device, the external space including the target position.

The devices or apparatus described above may be implemented as hardware components, software components, and/or a combination of hardware components and software components. For example, the devices and components described in the embodiments may be implemented using one or more general purpose computers or special purpose computers such as processors, controllers, arithmetical logic unit (ALU), digital signal processors, microcomputers, field programmable gate array (FPGA), programmable logic unit (PLU), microprocessor, or any other device capable of executing and responding to instructions. The processing device may perform an operating system (OS) and one or more software applications performed on the operating system. Further, the processing device may access, store, manipulate, process, and generate data in response to execution of the software. For convenience of understanding, although it may be described that one processing device is used, a person skilled in the art may appreciate that the processing device may include a plurality of processing elements and/or plural types of processing elements. For example, the processing device may include a single processor or a plurality of processors, and one controller. Furthermore, other processing configurations, such as a parallel processor, may be also possible.

The software may include computer programs, coded, instructions, or a combination of one or more of them, and configure the processing device to operate as desired or command the processing device independently or collectively. The software and/or data may be embodied in any type of machine, component, physical device, computer storage medium, or apparatus in order to be interpreted by a processing device or to provide instructions or data to the processing device. The software may be distributed over a networked computer system and stored or executed in a distributed manner. The software and data may be stored in one or more computer-readable recording media.

The method according to various embodiments of the disclosure may be implemented in the form of program instructions that may be performed through various computer means and recorded in a computer-readable medium. In such a circumstance, the medium may continuously store a computer-executable program or temporarily store the program for its execution or download. Further, the medium may be a variety of recording means or storage means in which a single or several hardware are combined and it is not limited to media directly connected to any computer system and may be distributed over the network. Examples of the medium may include magnetic media such as e.g., hard disks, floppy disks and magnetic tapes, optical recording media such as e.g., CD-ROMs and DVDs, magneto-optical media such as e.g., floptical disks, ROMs, RAMs, flash memories, or the like, which are configured to store program instructions. Examples of other medium may include app stores that distribute such applications, sites that supply or distribute various other software, and recording media or storage media managed by servers.

Heretofore, although various embodiments have been described with reference to some limited embodiments and drawings as above, various changes and modifications are possible from the above description to those of ordinary skill in the art. For example, even though the techniques described above are performed in a different order from the method described herein, and/or the components such as the aforementioned system, structure, device, circuit, and so on are coupled or combined in a different form from the method described herein or are substituted or replaced by other components or certain equivalents, appropriate results may be achieved.

Therefore, other implementations, other embodiments, and any equivalents to the appending claims fall within the scope of the claims to be described later.

What is claimed is:

1. An electronic device, comprising:
a display;
a camera;
a sensor; and
a processor, wherein the processor is configured to:
identify, based on data of the sensor, a first position of the electronic device;
obtain, in response to an external object identified using the camera, information for moving the external object based on the first position; and
while the external object is viewed through the display, display, based on the information, a visual object having a shape of a line extending from a second position in the display where the external object is viewed.

2. The electronic device of claim 1, wherein the processor is configured to display the visual object, based on a third position in an external space of the external object identified using the camera and a target position in the external space for the external object.

3. The electronic device of claim 2, wherein the processor is configured to display, on the display, the visual object having the shape of the line extending from the second position toward the target position.

4. The electronic device of claim 2, further comprising communication circuitry,
wherein the processor is configured to identify, based on an external electronic device connected via the communication circuitry, the external space including the target position.

5. The electronic device of claim 4, wherein the processor is configured to obtain the information, based on topography of the external space identified based on the external electronic device.

6. The electronic device of claim 4, wherein the processor is configured to obtain the information for moving the external object, based on weather condition of the external space identified using the external electronic device.

7. The electronic device of claim 6, wherein the processor is configured to:
identify, based on the weather, at least one of a direction or a velocity of wind to be applied to the external object, the external object including a golf ball, and
obtain the information, based on at least one of the direction or the speed.

8. The electronic device of claim 1,
wherein the visual object is a first visual object, and
wherein the processor is configured to:
obtain the information for recommending, from a plurality of golf clubs, one golf club to be utilized for moving the external object, the external object including a golf ball; and
display a second visual object related to the golf club to be recommended based on the information.

9. A method of an electronic device, comprising:
identifying, based on data of a sensor of the electronic device, a first position of the electronic device;
obtaining, in response to an external object identified using a camera of the electronic device, information for moving the external object based on the first position; and
while the external object is viewed through a display of the electronic device, displaying, based on the information, a visual object having a shape of a line extended from a second position in the display where the external object is viewed.

10. The method of claim 9, wherein the displaying comprises displaying the visual object based on a third position in an external space of the external object identified using the camera and a target position in the external space for the external object.

11. The method of claim 10, wherein the displaying comprises displaying, on the display, the visual object having the shape of the line extended from the second position toward the target position.

12. The method of claim 10, wherein the obtaining comprises identifying, based on an external electronic device connected via communication circuitry of the electronic device, the external space including the target position.

13. The method of claim 12, wherein the obtaining comprises obtaining the information, based on topography of the external space identified based on the external electronic device.

14. The method of claim 12, wherein the obtaining comprises obtaining the information for moving the external object, based on weather of the external space identified using the external electronic device.

15. The method of claim 14, wherein the obtaining comprises:
identifying, based on the weather, at least one of a direction or a speed of wind to be applied to the external object, the external object including a golf ball, and
obtaining the information based on at least one of the direction or the speed.

16. The method of claim 9,
wherein the visual object is a first visual object, and
wherein the obtaining comprises:
obtaining the information for recommending, from a plurality of golf clubs, one golf club to be utilized for moving the external object, the external object including a golf ball; and
displaying a second visual object related to the golf club to be recommended based on the information.

17. A non-transitory computer-readable storage medium storing one or more programs, the one or more programs comprising instructions that cause, when executed by a processor of an electronic device, to:
identify, based on data of a sensor of the electronic device, a first position of the electronic device;
obtain, in response to an external object identified using a camera of the electronic device, information for moving the external object based on the first position; and
while the external object is viewed through a display of the electronic device, display, based on the information, a visual object having a shape of a line extended from a second position in the display where the external object is viewed.

18. The non-transitory computer-readable storage medium of claim 17, wherein the one or more programs comprise instructions that cause, when executed by the processor of the electronic device, to display the visual object based on a third position in an external space of the external object identified using the camera and a target position in the external space for the external object.

19. The non-transitory computer-readable storage medium of claim 18, wherein the one or more programs comprise instructions that cause, when executed by the processor of the electronic device, to display, on the display, the visual object having the shape of the line extended from the second position toward the target position.

20. The non-transitory computer-readable storage medium of claim 19, wherein the one or more programs comprise instructions that cause, when executed by the processor of the electronic device, to identify, based on an external electronic device connected via communication circuitry of the electronic device, the external space including the target position.
